(19) United States
(12) Patent Application Publication
(10) Pub. No.: US 2026/0277990 A1
(43) Pub. Date: Sep. 17, 2026

(54) AUTONOMOUS ADAPTATIVE MULTI-MODAL ARTIFICIAL INTELLIGENCE MEDIA EDITING SYSTEMS AND METHODS

(71) Applicant: OpenExchange, Inc., Boston, MA (US)

(72) Inventors: Alexander J. Kieft, Arlington, MA (US); Sean M. Mullins, Brooklyn, NY (US); Joe C. McPherson, Rockwell, NC (US)

(21) Appl. No.: 19/553,124

(22) Filed: Feb. 27, 2026

Related U.S. Application Data
(60) Provisional application No. 63/765,481, filed on Feb. 28, 2025.

(51) Int. Cl. G06F 16/44; G06F 16/41; G06F 16/43

(52) U.S. Cl. CPC G06F 16/447; G06F 16/41; G06F 16/43

(57) ABSTRACT

Computational media editing systems and methods leveraging multi-modal machine learning models are provided. In an example, media files and a natural language editing prompt are received and processed using a multi-modal machine learning model configured to analyze visual and audio content. The system generates structured semantic metadata including scene information, transcription data, object tracking data, and timecodes. A timestamp reconciliation process aligns model-identified spoken content with timecoded speech-to-text data to improve temporal accuracy. Based on the analyzed metadata and the natural language prompt, a structured, non-executable project data object or executable instructions may be generated representing a media editing timeline including segment selections, transitions, effects, and asset references. In an embodiment, the structured project data object may be interpreted by a rendering engine that deterministically generates edited media output without executing model-generated source code. Supplemental media assets may be generated and integrated into the structured project representation prior to rendering.

### RELATED APPLICATIONS

This application claims the benefit of U.S. Provisional Application No. 63/765,481, filed on Feb. 28, 2025. The entire teachings of the above application are incorporated herein by reference.

### TECHNICAL FIELD

The disclosure relates generally to media editing systems and, more particularly, to systems and methods that leverage multi-modal large language models (LLMs) for automated editing of audio and video media through dynamic code generation and execution.

### BACKGROUND

Traditional digital media editing is a manual, timeline-based process, relying on basic functions such as cutting, trimming, layering, color correction, and audio synchronization. Non-linear editing (NLE) software systems, e.g., Adobe Premiere® Pro, Final Cut Pro®, and Da Vinci Resolve®, typically rely on human input to review media content, identify timecodes where edits should be made, and select an appropriate tool or expected feature to apply the changes before output media is produced.

### SUMMARY

Media editing has evolved significantly with the integration of artificial intelligence (AI) tools and features. Contemporary tools leverage AI for generative media creation streamlining the editing workflow. Generative media systems usually create new content from prompts and may not directly edit a specific input file. While some systems can accept reference inputs, prompt-driven generation is typically the core architecture. AI-assisted manipulation tools generally layer machine learning features onto conventional editing frameworks. The AI components often assist with discrete functions (e.g., masking, color adjustment, object tracking), while the overall workflow remains function-driven. Transcription-based editing platforms commonly link time-coded text to media timelines, allowing edits through text manipulation. Templated processing systems frequently apply rule-based or stylistic transformations according to predefined templates, which are conditionally triggered based on user input or detected features.

While advancements have been made in media editing, technical challenges remain. One issue is the difficulty AI tools face in accurately understanding complex context and subtleties, which can lead to errors in content generation or editing. For example, AI might struggle with correctly identifying and handling intricate details such as tone, facial expressions, or dialogue nuances, leading to unnatural results. Furthermore, AI models often necessitate vast amounts of data to perform optimally, and biases in training data can cause systematic flaws or inaccuracies in media output. Additionally, AI-driven editing tools may generate content that lacks the creative flexibility and problem-solving ability of human editors, particularly in complex projects that call for a high level of customization. These technical limitations highlight the ongoing desire for refinement and development in AI tools for media editing.

Example embodiments relate generally to media editing systems and, more particularly, to systems and methods that leverage multi-modal language models, e.g., large language models (LLMs), for automated editing of audio and video media through dynamic code generation and execution designed to overcome technical limitations identified above.

The present disclosure includes computer-implemented systems and methods for automated media editing that employ multi-modal machine learning models to generate a structured editing plan from media content and a natural language prompt.

In certain embodiments, an adaptive multi-modal media generation and editing system may be provided that is configured to analyze one or more input media files together with a natural language description of desired edits using a multi-modal large language model. The analysis may include scene detection, transcription processing, object tracking, and timecode identification. To improve temporal accuracy, the system may execute a timecoded speech-to-text transcription process in parallel with model analysis. Spoken excerpts identified by the model may be algorithmically matched to the timecoded transcript, and transcript-derived timestamps may replace model-generated timestamps when alignment thresholds are satisfied.

In further embodiments, an adaptive multi-modal media generation and editing system includes a structured intermediate asset generation process. Based on the prompt and media analysis results, the system generates a schema-conforming list of intermediate assets required to fulfill the editing request. Each asset entry specifies an asset type and associated generation parameters. The system routes asset requests to corresponding generation modules using a predefined enumeration of supported tools and services. Generated assets are incorporated into the structured project data object prior to rendering.

The system may be implemented in local or distributed computing environments and may support parallel processing, hardware acceleration, and scalable deployment architectures. The described features may be implemented individually or in combination.

Further, embodiments provide systems and methods for automated media editing that leverage multi-modal language models in an example two-stage process. In the first stage, a system accepts one or more media files, e.g., video or audio files, along with a natural language prompt that describes desired edits. The media files, potentially after preprocessing, such as frame extraction and/or segmentation for non-limiting examples, are fed into a multi-modal language model, e.g., an LLM, which generates an intermediate analysis. This analysis includes relevant information, e.g., timecodes, transcriptions, scene changes, object detections, and/or pixel coordinates, deemed necessary for editing based on requirements of the user prompt. The intermediate analysis is produced in a flexible format optimized for subsequent processing.

In the second stage, the intermediate analysis and the original user prompt are supplied to a code-generation language model, e.g., an LLM. This model is provided with detailed instructions—including specifications of a programming language, e.g., Python, a media editing library or application programming interface (API), e.g., ffmpeg, and characteristics of a target execution environment—to generate executable code that performs the desired edits on the input media files.

Before execution, the generated code is optionally validated using static analysis and/or code validation tools. If validation fails, error logs are captured and fed back to the code-generation language model for code revision. The ultimately validated code is then executed within a secure, sandboxed environment that enforces resource constraints and isolation to mitigate risks.

Rather than generating executable source code to perform editing operations as discussed above, in an alternate example embodiment, the system generates a structured, non-executable project data object conforming to a predefined schema. The structured project data object represents an editing timeline including segment selections, temporal boundaries, transitions, effects, and asset references. The structured project data object is interpreted by a rendering engine configured to deterministically execute media processing operations without executing arbitrary model-generated code. This separation between semantic planning and rendering improves reliability, determinism, and execution safety.

The resulting time-based output media file is optionally subjected to a computational quality evaluation process, where a multi-modal language model assesses whether the output adheres to the original prompt. If the output does not meet predefined quality thresholds, in an example embodiment, the system may automatically trigger a regeneration cycle or provide an option for manual re-generation.

Embodiments are adaptable to a range of deployment environments—from local, command-line interfaces to cloud-hosted web services—and can leverage techniques for data management, security, and/or media pre-processing.

An example embodiment is directed to a computer system for automated media editing using multi-modal language models. The system includes a media editing module. The module is configured to receive (i) a selection of at least one input media object, e.g., video object(s), and (ii) a first prompt. The first prompt includes an indication of at least one modification to the at least one input media object. The module is further configured to, based on the first prompt, process the at least one input media object using a first language model to generate an intermediate output. For instance, the system may be configured to construct a prompt to the first language model by combining pre-defined instructions with the first prompt. The intermediate output includes at least one parameter used to perform the at least one modification. The first language model is a multi-modal language model, e.g., a multi-modal LLM. The module is further configured to, based on the first prompt, process the intermediate output using a second language model, e.g., an LLM, to generate media editing code. The media editing code is configured to perform the at least one modification. The module is further configured to execute the media editing code to transform the at least one input media object into at least one time-based output media object, e.g., video object(s), by performing the at least one modification.

In an example embodiment, a media object of the at least one input media object may be a video object. The media editing module may further be configured to pre-process the video object by performing frame extraction to generate a plurality of video frames. According to one such embodiment, a rate of the frame extraction may be in a range of 1-30 frames per second (FPS). In another example embodiment, a media object of the at least one input media object may include an audio object. The media editing module may further be configured to pre-process the audio object by performing segmentation to generate a plurality of audio segments.

According to one such embodiment, a given segment of the plurality of segments may be paired with a corresponding metadata object. The metadata object may include a timecode of the segment in the media object. In another such embodiment, the plurality of segments may correspond to a respective plurality of context windows of the first language model. According to a further such embodiment, the media editing module may be configured to process the at least one input media object using the first language model by (1) generating a plurality of intermediate outputs corresponding to the plurality of segments and (2) aggregating the plurality of intermediate outputs to produce the intermediate output.

In an example embodiment, the at least one parameter may include at least one of: a transcription, a scene change, object detection, a timecode, and a pixel coordinate.

According to an example embodiment, the intermediate output may be in:

JavaScript® Object Notation (JSON) format, Extensible Markup Language (XML) format, plain text format, or a dynamic format determined by the first language model.

In an example embodiment, the media editing module may be further configured to, based on the first prompt, construct a first instruction prompt. The first instruction prompt may include at least one definition of the intermediate output. The media editing module may be configured to process the at least one input media object using the first language model based on the first instruction prompt.

In an example embodiment, the media editing module may be further configured to, based on (i) the first prompt and (ii) the intermediate output, construct a second instruction prompt. The second instruction prompt may include at least one of: (i) an indication of a programming language, (ii) an indication of at least one media editing component, and (iii) at least one property of a target execution environment. The media editing module may be configured to process the intermediate output using the second language model based on the second instruction prompt.

According to an example embodiment, the media editing module may be further configured to perform validation of the media editing code. The media editing module may be further configured to, responsive to a result of the validation indicating that the media editing code is not validated, process the intermediate output using the second language model to generate the media editing code, further based on the result of the validation.

In an example embodiment, the media editing code may be executed in a secure environment. According to one such embodiment, the secure environment may be configured with at least one of: (i) containerization, (ii) virtual machine isolation, (iii) one or more resource constraints, and (iv) one or more access control mechanisms.

In an example embodiment, the media editing module may be further configured to, based on the first prompt, process the at least one time-based output media object using a third language model to generate an output quality evaluation. The output quality evaluation may represent a degree of accuracy in performing the at least one modification. The third language model may be a multi-modal language model, e.g., a multi-modal LLM. the media editing module may be further configured to, responsive to the degree of accuracy being below a threshold value, (i) generate the intermediate output, (ii) generate the media editing code, and (iii) transform the at least one input media object. At least one of (i), (ii), and (iii) may be further based on the output quality evaluation. In one such embodiment, the output quality evaluation may include at least one of: (i) a numeric score, (ii) a natural language assessment, and (iii) a multidimensional assessment.

In an example embodiment, the first language model may include multiple language models. A given language model of the multiple language models may be configured to perform facial recognition or object detection.

In an example embodiment, the at least one modification may include: trimming, splicing, compositing, color correction, audio enhancement, subtitle addition. another operation performed by a timeline-based media editing system, or a combination thereof.

In an example embodiment, the at least one modification may include creation of a new media element. The media editing code may be further configured to create the new media element using a generative model.

The disclosure provides computer-implemented systems and methods for automated media generation and editing using coordinated multi-stage large language model (LLM) processing, including multi-modal analysis and programmatic edit synthesis.

In an example embodiment, in a first stage, one or more media files and a natural language edit prompt are processed by a multi-modal LLM configured to analyze visual, audio, and textual content. The system optionally performs preprocessing including adaptive frame sampling, scene segmentation, speech-to-text transcription, object detection, and metadata extraction. Large media files may be partitioned into temporally indexed chunks and processed in parallel across distributed compute nodes. The multi-modal LLM generates a structured intermediate representation comprising timecodes, detected entities, spatial coordinates, semantic annotations, edit-relevant metadata, and prompt-aligned transformation instructions.

According to an embodiment, in a second stage, the structured representation and the original prompt are supplied to a code-generation LLM configured to generate executable media-editing code. The system may incorporate retrieval-augmented generation to dynamically incorporate API documentation, execution constraints, and hardware characteristics. Generated code is validated using static analysis and executed in a sandboxed containerized environment with enforced resource constraints.

In certain embodiments, an adaptive multi-modal media generation and editing system is configured to generate executable software code representing editing instructions. For example, a machine learning model may generate source code in a programming language that, when executed, performs one or more requested media editing operations. While such embodiments are contemplated and remain within the scope of the present disclosure, it has been observed that model-generated executable code may exhibit syntactic or logical defects depending on model capability and runtime environment constraints.

Accordingly, in some example embodiments, the system generates a structured, non-executable project data object rather than executable source code. The structured project data object represents an editing project in a machine-readable format and may conform to a predefined schema. In certain implementations, the structured project data object may be formatted in JSON, XML, YAML, or other structured representation formats.

In some example embodiments, the system provides the multi-modal large language model with a schema defining permissible structural elements of a media timeline. The model generates output conforming to the schema, including one or more tracks containing media segment references, in-points, out-points, transitions, effects, volume adjustments, compositing instructions, and asset references. The structured project data object therefore encodes editing logic in declarative form rather than executable procedural code.

In some example embodiments, the structured project data object is interpreted by a separate rendering engine configured to deterministically execute media processing operations. The rendering engine executes only schema-conforming structured instructions and does not execute arbitrary model-generated source code. This architectural separation between semantic planning and deterministic rendering improves reliability, reduces runtime errors, and enhances execution safety. The structured project representation may further be validated against the schema prior to rendering and may be exported to standardized non-linear editing interchange formats for manual refinement.

Example embodiments provide a hybrid processing environment that enables the system to generate the intermediate data as interpreted data or executable data. For example, the hybrid processing may generate structured project data object in certain embodiments, and executable code generation in other environments. In this way, the hybrid processing environment of the system may selectively generate either executable code or structured project data objects depending on configuration, model capability, or runtime conditions.

In an example embodiment, the system includes one or more processors and non-transitory computer-readable memory storing a generative artificial intelligence multi-modal media editing module. The module includes an input interface configured to receive multimodal input data, including at least one selected media object (such as video, audio, image, or composite media) and a natural language edit prompt describing one or more desired modifications to the selected media object

In an example embodiment, a preprocessing module extracts temporally indexed media representations from the selected media object. These representations may include frame-level, segment-level, or time-aligned media features suitable for computational analysis.

In an example embodiment, a multi-modal machine learning model analyzes at least a portion of the temporally indexed media representations together with the natural language edit prompt. Based on this analysis, the model generates intermediate data comprising a machine-readable computational media editing artifact stored in memory. The intermediate artifact includes a timeline representation containing media segment references and associated edit parameters defining the requested modifications. A rendering engine processes the intermediate artifact to generate an edited media output.

In certain embodiments, the generative artificial intelligence module selectively generates the intermediate artifact in one of multiple formats depending on runtime conditions or system configuration. In some implementations, the intermediate artifact is generated as executable code configured to be executed by a processor to perform the requested edits. In other implementations, the intermediate artifact is generated as a structured, non-executable project data object that conforms to a predefined schema.

When generated as a structured project data object, the artifact includes the timeline representation, media segment references, and edit parameters encoded in a schema-constrained format. In certain embodiments, the project data object is generated using grammar-constrained decoding or schema validation techniques to ensure structural integrity and prevent malformed output. The structured artifact may be validated against the predefined schema prior to rendering.

In example structured-data embodiments, the rendering engine interprets the project data object and generates the edited media output without executing model-generated source code. The structured project data object may further be convertible into a standardized non-linear editing interchange format for interoperability with external media editing systems.

In alternative embodiments, the intermediate artifact is generated using a code-generation model configured to produce executable source code. In such implementations, the generated executable code encodes the timeline representation, media segment references, and edit parameters and is executable to generate the edited media output.

Accordingly, the system can provide a flexible architecture in which a multi-modal language model produces either executable instruction code or structured computational editing artifacts that are processed to generate edited media content, thereby enabling controlled, schema-constrained, and computationally efficient media transformation driven by natural language instructions.

In further embodiments, the system includes a structured intermediate asset planning stage. After analyzing input media and the natural language prompt, the system invokes one or more machine learning models to generate a structured list of intermediate assets that may be required to satisfy the editing request.

The system supplies the model with the original prompt, semantic analysis results, and a schema enumerating available asset-generation tools and supported asset categories. The schema may define asset types such as music, background audio, graphic overlays, text elements, animations, or other media components. For each asset entry, the model specifies an asset type and associated generation parameters.

The system receives the structured asset list and routes each asset request to an appropriate generation module using a lookup table or routing mechanism. For example, if the asset type corresponds to music generation, the request may be routed to an audio synthesis service. If the asset type corresponds to a graphic overlay, the system may generate markup or structured design instructions and render the result using a headless rendering engine to produce an image or video asset.

In certain embodiments, a single parent specification may produce multiple related assets, such as a series of lower-third overlays sharing formatting attributes but differing in textual content. Asset generation may occur in parallel with timeline construction and may be integrated into the structured project data object prior to rendering.

This formalized asset planning and routing process constrains tool invocation to predefined enumerations, improves determinism in asset selection, and enables modular extensibility of asset-generation capabilities. While such routing behavior may resemble tool-calling paradigms in large language models, its integration into a structured semantic editing pipeline forms part of the overall system architecture of the present disclosure.

In embodiments, the system improves temporal precision by executing a timecoded speech-to-text transcription process in parallel with multi-modal LLM analysis. The speech-to-text process generates word-level or phrase-level timestamps associated with spoken content in the input media.

When the multi-modal LLM analysis module identifies spoken excerpts relevant to the editing request and associates them with timestamps, the adaptive multi-modal media generation and editing system performs an automated reconciliation process. The text identified by the model is compared against the timecoded transcript using similarity matching techniques. Such techniques may include string similarity scoring, edit distance calculations, embedding similarity comparison, phonetic matching, or other alignment algorithms.

When a similarity threshold is satisfied, the system substitutes timestamp values derived from the timecoded transcript in place of the model-generated timestamps. This reconciliation process improves alignment accuracy while preserving the semantic selection determined by the model. The correction may occur automatically prior to structured project data object generation.

By combining semantic reasoning from the multi-modal LLM with deterministic timestamp alignment from a transcription engine, the system improves cut precision and reduces temporal drift in edited output.

Embodiments of the system, method, and computer program product may implement any one or more of the embodiments described herein, either individually or in combination. The features described above may be implemented in hardware, software, firmware, or combinations thereof, and may be deployed in local, distributed, cloud-based, or hybrid computing environments.

An example embodiment is directed to a computer-implemented method for automated media editing using multi-modal language models. The method is configured to implement any embodiments or combination of embodiments described herein.

An example embodiment is directed to a computer program product for computer-implemented method for automated media editing using multi-modal language models. The computer program product includes a non-transitory computer-readable medium with computer code instructions stored thereon. The computer code instructions are configured, when executed by a processor, to cause an apparatus associated with the processor to implement any embodiments or combination of embodiments described herein.

It is noted that embodiments of the system, method, and computer program product may be configured to implement any embodiments or combination of embodiments described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a schematic diagram of an example computer network environment in which embodiments are deployed.

FIG. 1B is a block diagram of the computer nodes in the network of FIG. 1A.

FIG. 2 is a block diagram of an example system for automated media editing according to an embodiment.

FIG. 3A is a block diagram of computer components of a multimedia player according to an embodiment.

FIG. 3B is a block diagram of computer components of a streaming media server according to an embodiment.

FIG. 4 is a flowchart of an example method of automated media editing according to an embodiment.

FIG. 5 is a flowchart of an example method of automated media editing according to another embodiment.

FIGS. 6A-6D are block diagrams of example user interfaces for an automated media editing user interaction sequence according to an embodiment.

FIG. 7 is a system architecture diagram of an example embodiment of an automated media editing system.

FIG. 8 is a system architecture diagram of an example embodiment of an automated media editing system within a networked computing environment.

FIG. 9 illustrates a diagram of an example embodiment of an automated media editing system employing structured semantic analysis, timestamp reconciliation, asset orchestration, and deterministic rendering.

### DETAILED DESCRIPTION

A description of example embodiments follows.

Example Drawbacks of Existing Approaches and Comparison to Embodiments Traditional media editing tools typically fall into one or more of the following categories:
a) Generative Media Creation: Tools that use generative AI to create new media outputs based solely on a prompt (e.g., Sora®, Veo®, Lumen5®). These systems generally do not modify the input media.
b) AI-Assisted Manipulation: Systems such as Adobe Premiere Pro (with Adobe Sensei®) or Runway, which utilize predefined AI or machine learning (ML) functions to assist in media manipulation, but rely on fixed editing functions.
c) Transcription-Based Editing: Tools like Descript®, which use timecoded transcriptions to facilitate editing through text-based interfaces.
d) Templated Processing: Systems like Magisto® that apply a set of predetermined, templated alterations to user-supplied media.

While the foregoing traditional approaches offer varying degrees of automation and intelligence, they generally impose limitations on a user's flexibility in describing a desired output. In contrast, embodiments enable a user to provide a natural language prompt describing desired edits and employ a novel two-stage process using multi-modal language models to dynamically generate executable code that performs the editing or dynamically generate an editing project timeline. The approach of embodiments is distinguished by its flexibility, adaptability to various media formats and editing requirements, and its feedback loop for quality evaluation and regeneration.

One conventional approach is a process that inputs a media stream as a source for a prompt that in turn generates new time-based output media. However, this approach lacks any process to edit the original source media. This approach can also display the generated output as an overlay over the source feed, but cannot edit the source media itself, and further lacks a mechanism to achieve that output by generating executable code.

Another existing approach is a process that leverages an LLM to generate executable code. However, this approach does not generate this code based on any input media. This approach also uses the resulting code to configure a video analytics pipeline that can analyze a video stream, but not edit or otherwise manipulate it.

### Example Digital Processing Environment

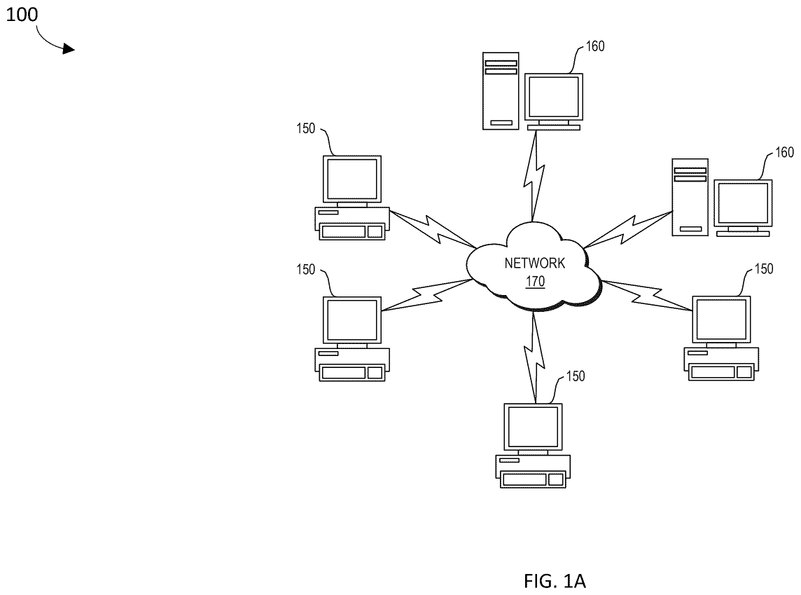

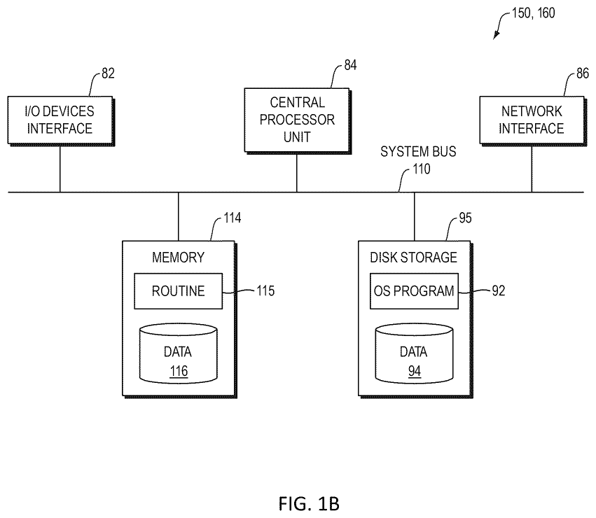

Example implementations of an adaptive multi-modal media generation and editing system 100 for automated media editing may be implemented in a software, firmware, or hardware environment. FIG. 1A illustrates one such environment. Client computer(s)/devices 150 (e.g., a mobile phone) and a cloud 160 (or server computer or cluster thereof) provide processing, storage, and input/output (I/O) devices executing application programs and the like.

The client computer(s)/device(s) 150 may be linked through communications network 170 to other computing devices, including other client device(s)/processor(s) 150 and/or server computer(s) 160. The communications network 170 may be part of a remote access network, a global network (e.g., the Internet), an out-of-band network, cloud computing servers or service, a worldwide collection of computers, local or wide area networks, and gateways that currently use respective protocols (e.g., TCP/IP, HTTP, Bluetooth®, etc.) to communicate with one another.

Other electronic device/computer network architectures are also suitable.

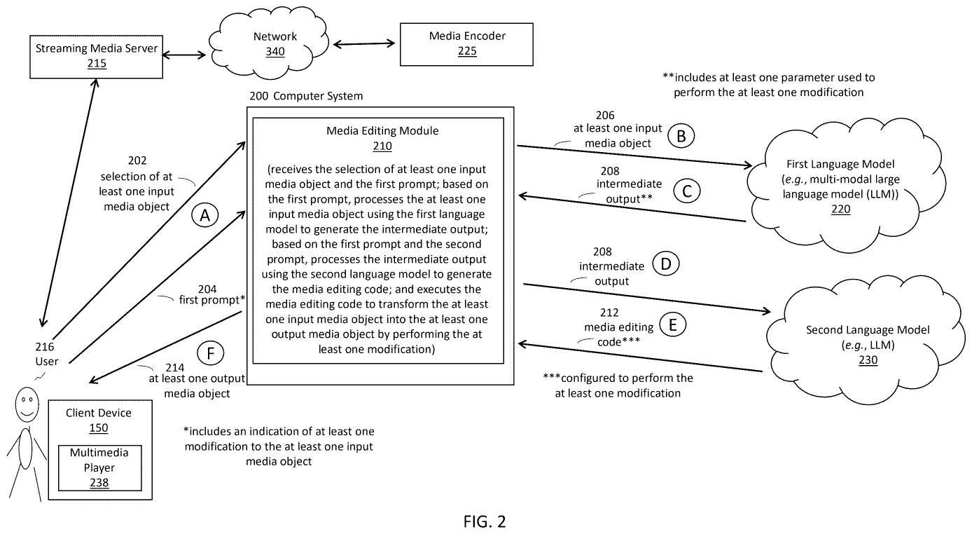

The server computer(s) 160 may be configured to implement a streaming media server (e.g., 215 of FIG. 2) for provisioning, formatting, and storing a live media stream (such as audio, video, text, and images/pictures) of a presentation, which may be processed and played at client computer(s)/devices 150 (such as multimedia player 238 in FIG. 2). The server computers(s) 160 may be communicatively coupled to client computer(s)/device(s) 150 that implement respective media editing modules (e.g., 210 of FIG. 2) for modifying, altering, or otherwise editing media object(s) that are transmitted to the server computer(s) 160. In one example embodiment, one or more of the server computer(s) 160 may be Java application server(s) that are scalable such that if there are spikes in traffic, the servers can handle the load increase.

FIG. 1B is a diagram of the internal structure of a computer/computing node (e.g., client processor/device/mobile phone device/tablet 150 or server computers 160) in the processing environment of FIG. 1A, which may be used to facilitate displaying such audio, video, image, or data signal information. Each computer 150, 160 contains a system bus 110, where a bus is a set of actual or virtual hardware lines used for data transfer among the components of a computer or processing system. The bus 110 is essentially a shared conduit that connects different elements of a computer system (e.g., processor, disk storage, memory, I/O ports, network ports, etc.) that enables the transfer of data and/or information between the elements. Attached to the bus 110 is I/O device interface 82 for connecting various input and output devices (e.g., keyboard, mouse, touch screen interface, displays, printers, speakers, etc.) to the computer 150, 160. Network interface 86 allows the computer to connect to various other devices attached to a network (for example the network illustrated at 170 of FIG. 1A). Memory 114 provides volatile storage for computer software instructions 115 and data 116 used to implement an embodiment of the present disclosure (e.g., capturing/loading, provisioning, formatting, retrieving, downloading, and/or storing live media streams and/or streams of user-initiated commands, the automated media editing functionality described herein, etc.).

Disk storage 95 provides non-volatile storage for computer software instructions 92 (equivalently “OS program”) and data 94 used to implement embodiments of the adaptive multi-modal media generation and editing system 100 of the present disclosure. Central processor unit 84 is also attached to the bus 110 and provides for the execution of computer instructions.

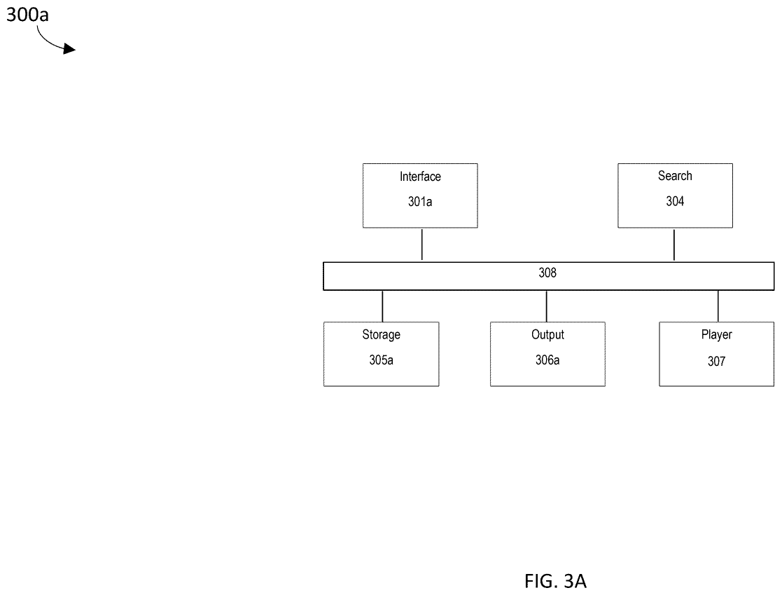

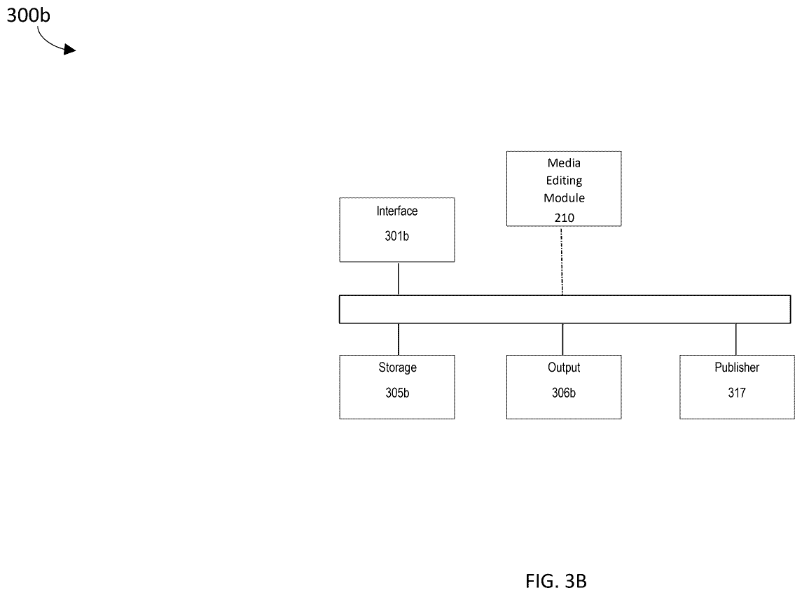

In one embodiment, the processor routines 92 and data 94 are a computer program product, including a non-transitory, computer readable medium (e.g., a removable storage medium such as a DVD-ROM, CD-ROM, diskette, tape, etc.) that provides at least a portion of the software instructions for the adaptive multi-modal media generation and editing system 100. Instances of the media editing module 210 (FIG. 2), first language model 220 (FIG. 2), second language model 230 (FIG. 2), multimedia player 238 (FIG. 2), player 307 (FIG. 3A), publisher 317 (FIG. 3B), and other software embodiments of the adaptive multi-modal media generation and editing system 100 may be implemented as a computer program product 92, and can be installed by any suitable software installation procedure, as is well known in the art. In another embodiment, at least a portion of the adaptive multi-modal media generation and editing system 100 instructions may also be downloaded over a cable, communication and/or wireless connection. In other embodiments, the adaptive multi-modal media generation and editing system 100 software components may be implemented as a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the adaptive multi-modal media generation and editing system 100 routines/program 92.

Generally speaking, the term “carrier medium” or transient carrier encompasses the foregoing transient signals, propagated signals, propagated medium, storage medium, and the like.

In further example embodiments, the propagated signal is an analog carrier wave or digital signal carried on the propagated medium. For example, the propagated signal may be a digitized signal propagated over a global network (e.g., the Internet), a telecommunications network, an out-of-band network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of the computer program product 92 is a propagation medium that the computer system 150 may receive and read, such as by receiving the propagation medium and identifying a propagated signal embodied in the propagation medium, as described above for computer program propagated signal product.

In other embodiments, the program product 92 may be implemented as a so-called Software as a Service (Saas), or other installation or communication supporting end-users.

The adaptive multi-modal media generation and editing system 100 described herein may be configured using any known programming language, including any high-level, object-oriented programming language. A client computer/device 150 (e.g., multimedia player 238 of FIG. 2) of the multimedia system 100 may be implemented via a software embodiment and may operate within a browser session. The adaptive multi-modal media generation and editing system 100 may be developed using HTML, JavaScript, Flash, and such. The HTML code may be configured to embed the system into a web browsing session at a client 150. The JavaScript code may be configured to perform clickstream and session tracking at the client 150 (e.g., publisher 317 of FIG. 3B) and store the streaming media recordings and editing data in a cache. In another embodiment, the system may be implemented in HTML5 for client devices 150 that do not have Flash installed and use HTTP Live Streaming (HLS) or MPEG-DASH protocol. The system may be implemented to transmit media streams using a real-time streaming protocol, such as: Real-Time Messaging Protocol (RTMP), Real-Time Streaming Protocol (RTSP), Web Real-Time Communications (WebRTC), and the like. Components of the adaptive multi-modal media generation and editing system 100 may be configured to create and load an XML, JSON, or CSV data file or other structured metadata file (such as a manifest file) with information about where and how components of the adaptive multi-modal media generation and editing system 100 are stored, hosted, or formatted, such as timing information, size, footnote, attachments, interactive components, style sheets, etc.

In an example mobile implementation, the user interface framework for the components of the adaptive multi-modal media generation and editing system 100 may be based on XHP, Javelin, and/or WURFL. In another example mobile implementation for OS X and iOS operating systems and their respective APIs, Cocoa and Cocoa Touch may be used to implement the player 307 using Objective-C or any other high-level programming language that adds Smalltalk-style messaging to the C programming language.

### Example System for Automated Media Editing

FIG. 2 is a block diagram of an example computer system 200 in which an adaptive multi-modal media generation and editing system 100 may be implemented for automated media editing according to an embodiment. In the example embodiment of FIG. 2, the system 200 comprises a media editing module 210. The system 200 is an example implementation of the computer network environment of the adaptive multi-modal media generation and editing system 100 of FIG. 1A. In the example embodiment of FIG. 2, at step A the module 210 receives a selection of at least one input media object 202 and a first prompt 204, e.g., from user 216 operating client device 150, which includes multimedia player 238. The first prompt 204 includes an indication of at least one modification to at least one input media object 206. At step B, based on the first prompt 204, the module 210 processes at least one input media object 206 using first language model 220, e.g., a multi-modal LLM. The first model 220 then generates intermediate output 208 at step C. The intermediate output 208 includes at least one parameter used to perform the at least one modification. Next, at step D, based on the first prompt 204, the module 210 processes the intermediate output 208 using second language model 230, e.g., an LLM. At step E, the second model 230 generates media editing code 212. The media editing code 212 is configured to perform the at least one modification. In turn, at step F, the module 210 executes the media editing code 212 to transform the at least one input media object 206 into at least one time-based output media object 214 by performing the at least one modification.

The example system 200 may include a media encoder 225 that captures, loads, or otherwise provides a live media stream (containing media content, e.g., at least one input media object) to a streaming media server 215. In some embodiments, the media encoder 225 may be: Wirecast®, Adobe Live Media Encoder, TriCaster®, Zoom Video Webinar, Pexip® Infinity, and the like. In some embodiments, the streaming media server 215 may be Wowza Streaming Engine®, Adobe Media Server, or a cloud-hosted SaaS/PaaS provider, including one of: Brightcove® Live Streaming Service, Zencoder® Live Transcoding, Encoding. com Live Cloud Encoding, Amazon Web Services (AWS) Elemental MediaLive®, Wowza Streaming Cloud®, or such. The media content of the live media stream may be audio and/or video, and the like. In example embodiments, the live media stream may contain video content, which is being captured live (in real-time) from a camera/recorder (e.g., webcam) configured on the media encoder 225, a camera/recorder communicatively coupled to the media encoder 225, or any other such live capture of video. In other embodiments, the video content of the live media steam may be pre-recorded videos stored on the media encoder 225 or at a storage device communicatively coupled to the media encoder 225, a live video feed from a web link accessible from the media encoder 225, and such.

In example embodiments, the captured video content of the video stream may be formatted as MPEG-4, Windows Media®, Quicktime®, Audio Video Interleave (AVI), Flash, or any other video format without limitation. In some example embodiments, the video stream may also be transcoded (video encoded) or otherwise digitally converted for transfer and use at the streaming media server 215 and multimedia player 238. The video stream (or other media stream) may be transferred to the streaming media server 215 and multimedia player 238 using RTMP or HLS or other such streaming protocol.

The streaming media server 215 receives the (continuous) live media stream from the media encoder 225 over network 340. The streaming media server 215 is configured to generate and maintain a time-based output media stream playlist such that the playlist maintains all references to older media segments while gaining new references, throughout the full duration of the stream (e.g., two hours). The streaming media server 215 provides a dedicated memory location (e.g., directory or folder) for storing the live media stream. The streaming media server 215 provisions the received live media stream for playback on multimedia player 238. The streaming media server 215 transcodes the live media stream into segments or packets of a target time length, which are stored at the dedicated memory location. The streaming media server 215 also creates and updates a metadata file or structure (e.g., playlist file), such as in a text, XML, or CSV file, with information on the sequence of segments or packets of the live media stream. The information stored in the playlist file includes information on each stored segment of the live media stream, such as where stored, hosted, identifier, date, time, size (time length), and the like. The stored segments and playlist file may be structured according to the player configuration of the multimedia player 238, such as in HTML5-capable browser client.

Based on the playlist file, the multimedia player 238 retrieves the live (continuous) media stream from the streaming media server 215, and may cache the live media stream at the multimedia players. The multimedia player 238 displays the live media stream via respective media players (e.g., HTML5 Video Player or the like) configured on the multimedia player 238 via a web browser. The live media stream may be displayed in a first window or panel of a multimedia player 238.

An example system of embodiments may be supplied with a media file and a natural-language prompt to edit the media file in a desired manner. The system may perform the edits requested and return an output file. In an embodiment, the system may feed a source media (e.g., video or audio) file to a multi-modal language model, e.g., LLM, along with a user's requested edits. The language model may be prompted to analyze the media file, extract data needed to make the edits, and send the data back to the system. Then the system may use that data to prompt a second language model, e.g., LLM, to generate executable code to perform the edits, e.g., by invoking a particular video editing library's API. In turn, the system may execute the code that the second language model generates, e.g., by executing the code with the video editing library to produce edited video output.

An example embodiment can overlay names of speakers in a video file, or create a compilation of every time one of the speakers raised their eyebrows. In these examples, an original user prompt may not specify the names of the speakers, or the times when they raised their eyebrows. Rather, an example embodiment may leverage a language model, e.g., LLM, to identify this information by analyzing the video, and supply the information back as, e.g., timecoded data that may then be used to generate code instructions to apply edits to the video.

### Example System Components for Automated Media Editing

FIG. 3A is a block diagram 300a of example computer components of the multimedia player 238 of FIG. 2 according to an embodiment. The multimedia player 238 includes an interface 301a configured to retrieve at least one time-based output media object 214 from a media editing module 210. The multimedia player 238 includes storage 305a, which may retain or cache the at least one time-based output media object 214 for later viewing, or to enable various playback controls such as pause and rewind. The multimedia player 238 includes a player 307 configured to play the at least one time-based output media object 214 (received via interface 301a) and a search engine 304 configured to locate a particular point in the at least one time-based output media object 214. In some embodiments, the player 307 is a HTML5 Video Player using video.js. The multimedia player 238 also includes an output module 306a configured to display the at least one time-based output media object 214. The output module 306a may trigger an on-screen event from a command received via interface 301a. Data may travel among the various components shown in the diagram 300a of FIG. 3A via system bus 308.

FIG. 3B is a block diagram 300b of example computer components of the streaming media server 215 of FIG. 2 according to an embodiment. The streaming media server 215 includes an interface 301b configured to receive a selection of at least one input media object 202 and a first prompt 204 from a user 216. The streaming media server 215 includes storage 305b, which may host at least one time-based output media object 214. The at least one time-based output media object 214 may optionally be hosted remotely from the streaming media server 215, such as at another server on the network 340.

The streaming media server 215 can be seen in FIG. 3B to interface with a media editing module 210, as illustrated in the figure with a dotted line. The streaming media server 215 may transmit the selection of at least one input media object 202 and the first prompt 204 to the media editing module 210. The media editing module 210 of the adaptive multi-modal media generation and editing system may perform automated media editing of at least one input media object 206 and transmit the at least one time-based output media object 214 back to the streaming media server 215. In turn, the streaming media server 215 may transmit the at least one time-based output media object 214 to the user 216 via the interface 301b.

The streaming media server 215 can be seen in FIG. 3B to also include a publisher 317 configured to enable the user to create, update, and load media content, such as audio, video, text, or graphic image content, and trigger a stream of commands on the loaded media content (such as, for loaded media content of a slide presentation, selecting a new slide). The streaming media server 215 also includes an output module 306b configured to display the at least one time-based output media object 214. The output module 306b may trigger an on-screen event from a command received via interface 301b.

### Example Methods of Automated Media Editing

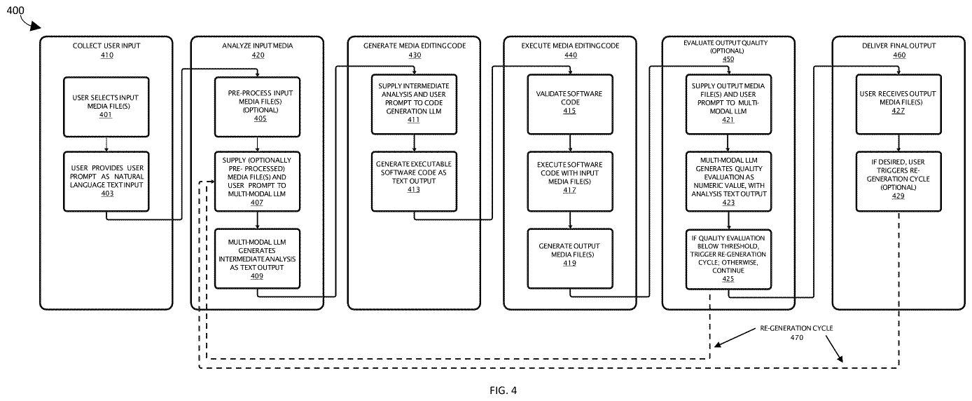

FIG. 4 is a flowchart of an example method 400 of automated media editing according to an embodiment. In a user input collection phase 410, at step 401, the method 400 receives a user selection of one or more media file(s). At step 403 in phase 410, the method 400 receives a natural language prompt from the user.

The method 400 continues from phase 410 to input media analysis phase 420. Optionally as part of phase 420, at step 405, the method 400 may pre-process the input media file(s) received at step 401. At step 407 in phase 420, the method 400 supplies the (optionally pre-processed) media file(s) and the user prompt (received at step 403) to a multi-modal LLM. Then, at step 409 in phase 420, the method 400 employs the multi-modal LLM to generate an intermediate analysis.

Following phase 420, the method 400 enters media editing code generation phase 430. At step 411 in phase 430, the method 400 supplies the intermediate analysis (generated at step 409) and the user prompt (received at step 403) to a code generation LLM. In turn, at step 413 in phase 430, the method 400 utilizes the code generation LLM to produce executable software code.

The method 400 continues from phase 430 to media editing code execution phase 440. At step 415 in phase 440, the method 400 validates the editing code generated at step 413.

The method 400 then runs the code at step 417 in phase 440 to process the input file(s). At step 419 in phase 440, the method 400 uses the code to generate one or more time-based output media file(s).

Following phase 440, the method 400 may optionally enter output quality evaluation phase 450. At step 421 of optional phase 450, the method 400 may supply the time-based output media file(s) generated at step 419 and the user prompt to the multi-modal LLM. The method 400 may then employ the multi-modal LLM at step 423 of optional phase 450 to generate a quality evaluation. In turn, at step 425 of optional phase 450, if the quality evaluation at step 423 is below a threshold, the method 400 may trigger a re-generation cycle 470. A re-generation cycle 470 causes the method 400 to return to step 407 in phase 420. Otherwise, if the quality evaluation at step 423 meets or exceeds the threshold, the method 400 may proceed to final output delivery phase 460.

The method 400 reaches phase 460 either directly from step 419 in phase 440 or after optionally entering phase 450. At step 427 in phase 460, the method 400 provides the output file(s) generated at step 419 to the user. Optionally as part of phase 460, at step 429, in response to a user request, the method 400 may trigger a re-generation cycle 470, thereby causing the method 400 to return to step 407 in phase 420.

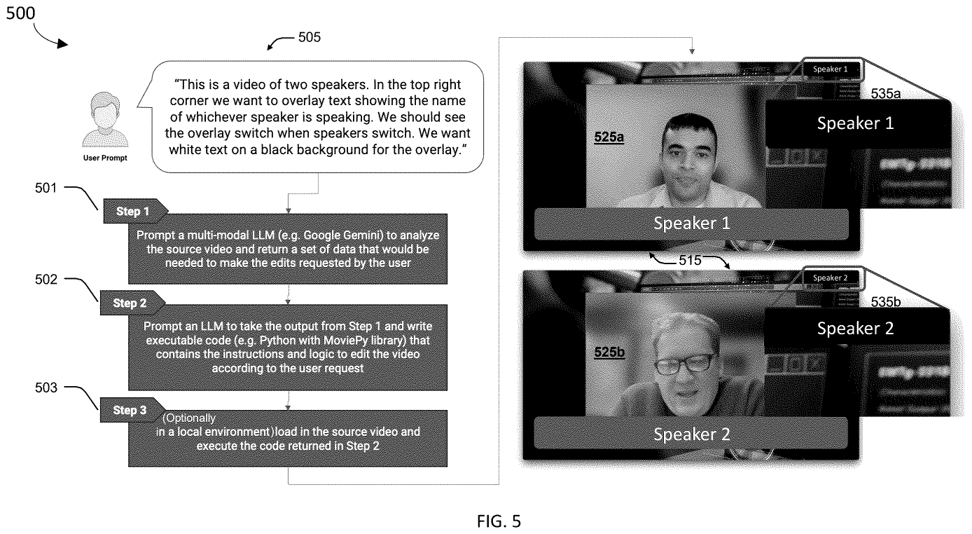

FIG. 5 is a flowchart of an example method 500 of automated media editing according to another embodiment. The method 500 begins at step 501 by receiving a user selection of an input media file (not shown) and a user prompt 505, e.g., a request in text format. As an illustration, the input file may be a video 515 of two speakers 525a and 525b. The accompanying prompt 505 may describe an edit to display overlay text 535a/535b in the top right corner of the video with the name of the current speaker in white font on a black background and further to update the overlay when switching to a different speaker. Continuing with step 501, optionally after pre-processing the input file, the method 500 employs a multi-modal language model (e.g., an LLM such as Google Gemini) to process the input file and the prompt 505. Based on an analysis of the input file based and the prompt 505, the multi-modal model generates an intermediate output, i.e., a set of data that can be used to implement the edit described by the prompt 505. In an embodiment, the intermediate output may be in text format.

At step 502, the method 500 then utilizes a code-generation language model (e.g., LLM) to process the intermediate output of step 501 together with the prompt 505 and generate executable code (e.g., Python code leveraging the MoviePy video editing library). The executable code generated at step 502 includes instructions and/or logic to edit the input file according to the user request 505.

In turn, at step 503, the method 500 executes the code generated at step 502 to process the input media file and implement the edit described in the user prompt 505, which, for instance, results in modifying the video 515 to include the overlays 535a and 535b corresponding to the speakers 525a and 525b. According to an embodiment, the code may be executed at step 503 in the user's local environment (not shown).

### Example Automated Media Editing User Interaction Sequence

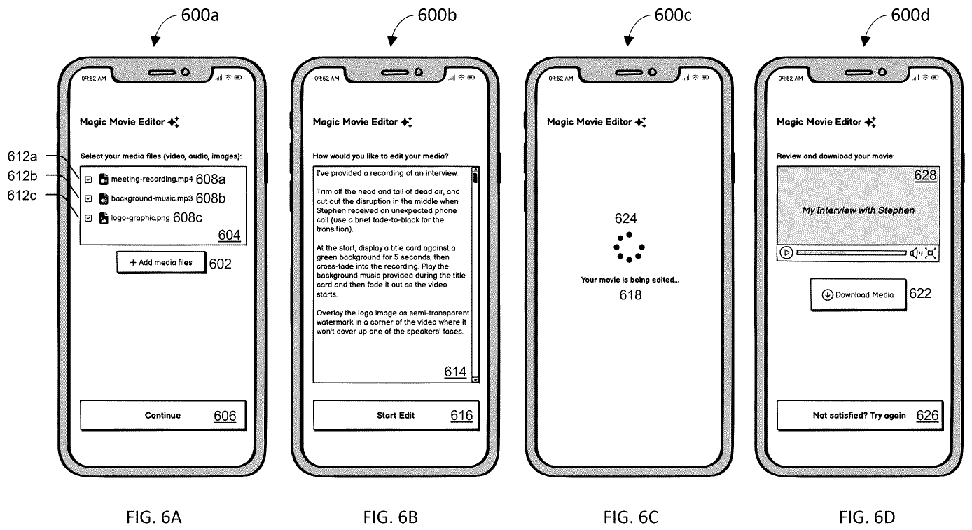

FIGS. 6A-6D are block diagrams of example user interfaces 600a-600d, respectively, for an automated media editing user interaction sequence according to an embodiment. The interfaces 600a-600d may be provided on a client device 150 (FIG. 1A), e.g., a smartphone or other mobile device. As shown in FIG. 6A, the interface 600a includes input media object selection button 602, input media object display window 604, and confirmation button 606. In an embodiment, a user may invoke or activate the button 602 one or more times as needed to select at least one input media object for automated editing. The selected input media object(s) may be displayed in the window 604, and may include video object(s) 608a (e.g., MPEG-4 (.mp4) file(s)), audio object(s) 608b (e.g., MPEG-1 or MPEG-2 Audio Layer III (.mp3) file(s)), and/or image object(s) 608c (e.g., Portable Network Graphics (.png) file(s)), for non-limiting examples. The user may also exclude previously selected media object(s) from the automated media editing process by unchecking one or more of checkboxes 612a-612c corresponding to the media objects 608a-608c. By invoking or activating the button 606, the user may confirm a selection of input media object(s) as displayed in the window 604 and proceed to providing an editing prompt.

With reference to FIG. 6B, the interface 600b may be provided in response to invocation or activation of the button 606 in the interface 600a. The interface 600b includes text area 614 and start button 616. In an embodiment, a user may employ the text area 614 to enter a first prompt including an indication of at least one modification to at least one input media object. Entry of the first prompt in the text area 614 may be accomplished using a physical keyboard, a virtual keyboard, a voice-to-text feature, or any other suitable mechanism known in the art. By invoking or activating the button 616, the user may confirm contents of the first prompt in the text area 614 and commence the automated media editing process of the adaptive multi-modal media generation and editing system based on the first prompt and a prior selection of at least one input media object via the interface 600a.

With reference to FIG. 6C, the interface 600c may be provided in response to invocation or activation of the button 616 in the interface 600b. The interface 600c includes progress message 618 and progress indicator 624. In an embodiment, the message 618 may be displayed to indicate that automated media editing is currently being performed on at least one input media object selected via the interface 600a based on a first prompt input via the interface 600b. According to another embodiment, the indicator 624 may be a graphical and/or textual element that is displayed to inform a user that the automated media editing operation is in progress. In an embodiment, the indicator 624 may be a progress bar, a pinwheel, a throbber, a percentage figure, an hourglass, or any other suitable element known in the art, and may be determinate or indeterminate.

With reference to FIG. 6D, the interface 600d may be provided upon completion of an automated media editing operation and subsequent to providing the interface 600c. The interface 600d includes media player 628, media download button 622, and re-generation button 626. In an embodiment, the player 628 may be used to review or preview at least one time-based output media object resulting from automated media editing performed on at least one input media object selected via the interface 600a based on a first prompt input via the interface 600b. According to another embodiment, providing the player 628 enables a user to verify accurate implementation of the first prompt's at least one modification to the at least one input media object prior to invoking or activating the button 622 to download the at least one time-based output media object, which may consume storage capacity on the client device 150. In an embodiment, by invoking or activating the button 626, the user may cause an output re-generation process to occur using the at least one input media object and the first prompt.

### Example System Architecture

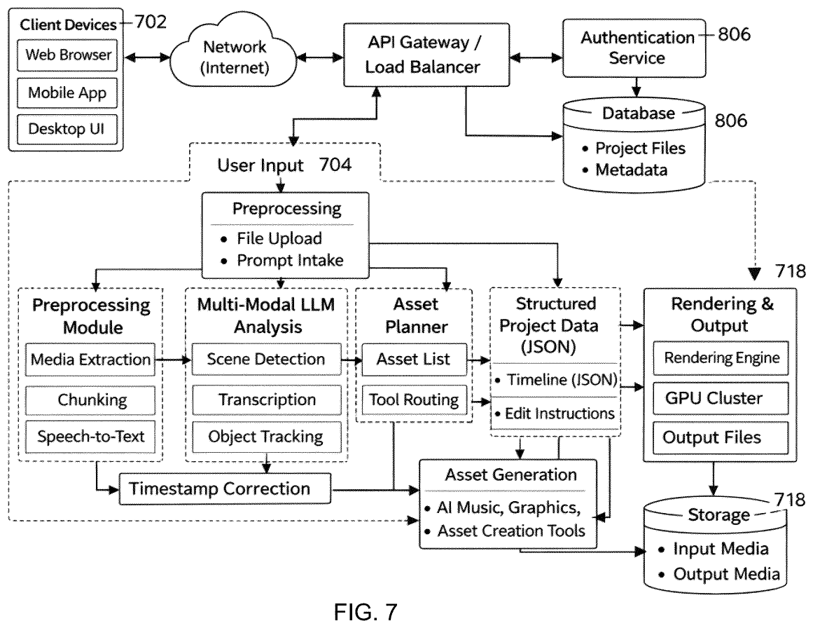

FIG. 7 is a system architecture diagram of an example embodiment of an adaptive multi-modal media generation and editing system for automated media editing. The computational system architecture and workflow of the adaptive multi-modal media generation and editing system 700, for example, can provide a structured, deterministic editing pipeline in which semantic planning, timestamp correction, asset generation, and rendering are logically separated. Client devices 702, 150 which may include a web browser, mobile application, or desktop user interface, communicate over a network 170 to submit media files and editing prompts. A user input stage 704 receives file uploads and natural language prompt intake.

The media files are supplied to a preprocessing module comprising media extraction, chunking, and speech-to-text operations. The preprocessing module extracts visual frames and audio data, segments large files, and generates timecoded transcription data where applicable.

The preprocessed media and user prompt are provided to a multi-modal LLM analysis module. The multi-modal LLM analysis module performs scene detection, transcription interpretation, object tracking, and timestamp identification based on the input media.

A timestamp correction module reconciles timestamps generated by the multi-modal LLM with timecoded speech-to-text output to improve temporal accuracy of selected media segments. An asset planner module generates a structured asset list and performs tool routing. The asset planner determines whether additional assets are required to fulfill the user's editing request. A structured project data module generates a structured project data object (JSON), including a timeline representation and edit instructions. The structured project data object includes timeline segments, transitions, and asset references. An asset generation module generates supplemental media assets such as music, graphics, or other media elements. Asset creation tools may be invoked as needed.

A rendering and output module 718 includes a rendering engine, GPU cluster resources, and output file generation components. The rendering engine interprets the structured project data and generates final edited media output files. A storage component 718, 95 may store input media and output media files.

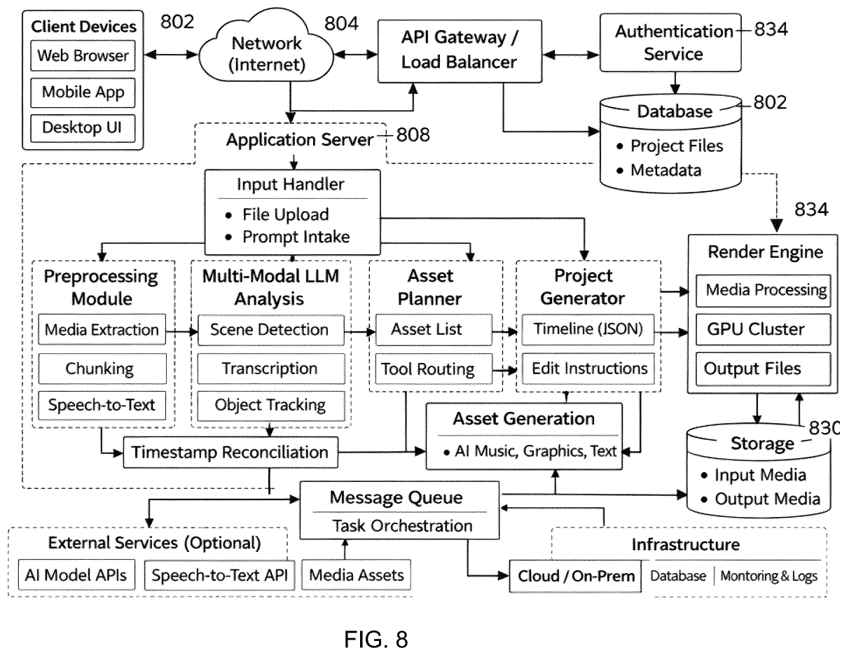

FIG. 8 is a system architecture diagram of an example embodiment of an adaptive multi-modal media generation and editing system 800 within a networked computing environment. As discussed in more detail here, the system 800 may be preferably configured to provide a scalable, distributed computing framework that supports modular processing, parallel asset generation, GPU-accelerated rendering, and secure multi-user access. Client devices 802, 150 including web browsers, mobile applications, and desktop interfaces, communicate over a network 804 with an API gateway or load balancer. The API gateway routes requests to an application server 808, 160. The application server includes an input handler that manages file upload and prompt intake. The application server coordinates a preprocessing module configured to perform media extraction, chunking, and speech-to-text processing. A multi-modal LLM analysis module executes machine learning models for scene detection, transcription processing, and object tracking. A timestamp reconciliation module improves temporal accuracy by matching model-identified speech excerpts with timecoded transcription data. An asset planner module generates structured asset lists and performs tool routing to asset generation services. A project generator module produces a structured project data object representing the editing timeline in JSON format, including edit instructions.

A render engine 826 performs media processing operations and may utilize GPU cluster resources. The render engine generates output files based on the structured project data. A storage system 830, 95 stores input media and output media files. A database 802 stores project files and metadata. An authentication service 834 manages user access control. A message queue provides task orchestration for coordinating asynchronous processing among system modules. External services 838 may include AI model APIs, speech-to-text APIs, and media asset providers. Infrastructure components 836 support cloud or on-premises deployment, database management, and monitoring and logging functions.

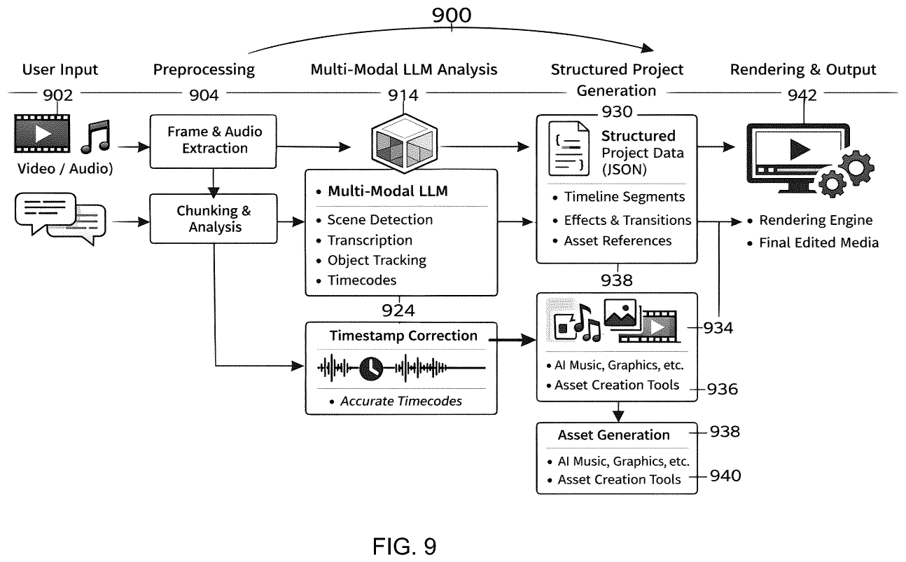

FIG. 9 illustrates a diagram of an example embodiment of an adaptive multi-modal media generation and editing system 900 employing structured semantic analysis, timestamp reconciliation, asset orchestration, and deterministic rendering.

A user input stage 902 receives one or more media files 904 and a natural language prompt 906. The media files 904 may include video, audio, image, or composite media content. The natural language prompt 906 describes one or more desired edits, transformations, or compositing operations. By accepting high-level semantic intent rather than fixed editing commands, the system enables adaptive editing workflows.

The media files 904 are supplied to a preprocessing stage 908. The preprocessing stage 908 may include frame and audio extraction 910 and chunking and analysis 912. Frame and audio extraction 910 separates visual frames and audio streams to facilitate parallel processing. Chunking and analysis 912 divides large media assets into temporally indexed segments. Chunking improves scalability and enables distributed processing across compute nodes while preserving temporal continuity through metadata tagging.

Output from the preprocessing stage 908 is provided to a multi-modal large language model (LLM) analysis module 914. The multi-modal LLM analysis module 914 analyzes both media content and the natural language prompt 906 to generate structured semantic metadata. The module 914 may perform scene detection 916, transcription 918, object tracking 920, and timecode identification 922. These processes allow the system to interpret semantic meaning, identify relevant moments in media, and associate those moments with temporal markers.

Because model-generated timestamps may exhibit temporal imprecision, a timestamp correction module 924 is provided. The timestamp correction module 924 reconciles timestamps generated by the multi-modal LLM analysis module 914 with timecoded speech-to-text data. When similarity thresholds are satisfied, corrected timestamps 926 are substituted. This hybrid approach leverages semantic reasoning from the LLM while relying on deterministic transcription alignment for temporal precision. The result is improved cut accuracy and reduced downstream rendering errors.

Structured semantic output is supplied to a structured project generation module 928. The structured project generation module 928 generates a structured project data object 930, which may be formatted in JSON or another structured schema. The structured project data object 930 may include timeline segments 932, effects and transitions 934, and asset references 936. By generating a non-executable structured data object rather than executable source code, the system improves reliability, enables schema validation prior to rendering, reduces execution risk, and improves interoperability with external editing environments.

An asset generation orchestration module 938 determines whether supplemental assets are required to satisfy the prompt 906. The module 938 may invoke asset creation tools 940 to generate AI-generated music, graphics, text overlays, animations, or other media components. Asset generation may occur in parallel with timeline construction, and generated assets may be incorporated into the structured project data object 930. This formalized asset orchestration improves completeness of edits and reduces manual intervention.

The structured project data object 930 is supplied to a rendering engine 942. The rendering engine 942 interprets the structured project representation deterministically and generates final edited media output 944. The rendering engine 942 may utilize GPU acceleration, distributed rendering clusters, or hardware encoding pipelines. Because the rendering engine 942 executes structured instructions rather than model-generated arbitrary code, the execution environment may be more secure and predictable.

The workflow 900 therefore establishes a layered architecture in which semantic reasoning (module 914), temporal correction (module 924), structured planning (module 928), asset synthesis (module 938), and deterministic rendering (module 942) are logically separated components. This separation improves modularity, scalability, and maintainability relative to monolithic AI editing systems.

In some embodiments, the adaptive multi-modal media generation and editing system 900 may enable improved temporal precision. Timestamp reconciliation 924, for example, combined with semantic extraction can enable deterministic transcription alignment, improving cut accuracy.

Further, in some embodiments, the adaptive multi-modal media generation and editing system 900 may enable deterministic execution because the structured project data generation 928 can help avoid direct execution of LLM-generated code, reducing runtime failures.

In some embodiments, the adaptive multi-modal media generation and editing system 900 may provide schema validation. By providing schema validation, the structured project data object 930 may be validated prior to rendering.

In some embodiments, the architecture of the adaptive multi-modal media generation and editing system 900 can improve scalability and processing time by providing parallel processing architecture. Chunking 912, for instance, supports distributed inference and scalable compute architectures.

System performance of the adaptive multi-modal media generation and editing system 900 may be augmented by implementing modular asset orchestration in some embodiments. For example, the asset planning 938 computational architectures can separate asset determination from generation, enabling extensibility and tool routing, thereby improving system performance and processing time.

In some embodiments, the adaptive multi-modal media generation and editing system 900 can provide enhanced hardware acceleration compatibility by configuring the rendering engine 942 to utilize GPU clusters without modifying semantic planning logic. For example, semantic planning logic is configured to provide the reasoning layer that determines what edits should occur and where they should occur in the media. That logic is performed upstream of the rendering engine and can be embodied primarily, for example, in the multi-modal LLM analysis 914, timestamp correction 924, structured project generation 925, and the resulting structured project data object 930. The rendering engine 942 executes this semantic plan and avoids altering it.

In some embodiments, the system 900 employs a layered architecture in which semantic planning logic is logically separated from deterministic rendering execution. The semantic planning logic is performed upstream of the rendering engine 942 and is not modified by the rendering engine during media output generation. This semantic planning layer includes the multi-modal LLM analysis module 914, the timestamp correction module 924, and the structured project generation module 928, which collectively generate the structured project data object 930.

In an example implementation, the multi-modal LLM analysis module 914 is configured to interpret the natural language prompt 906 in the context of the input media files 904. This module performs semantic analysis including scene detection 916, transcription analysis 918, object tracking 920, and timecode identification 922. Through these processes, the system determines which portions of the media correspond to the intent expressed in the prompt 906 and identifies candidate media segments for inclusion or modification. The output of this module represents a semantic understanding of the content and the requested transformation.

Because model-generated timestamps may exhibit imprecision, the timestamp correction module 924 reconciles timestamps generated by the multi-modal LLM analysis module 914 with timecoded transcription data. When a sufficient similarity threshold is met, corrected timestamps 926 are substituted. This reconciliation improves temporal precision while preserving the semantic selections identified by the model.

The structured project generation module 928 then generates a structured project data object 930 representing the complete edit plan. The structured project data object 930 may include timeline segments 932, effects and transitions 934, and asset references 936. This structured object encodes semantic decisions regarding which media segments to use, how they are arranged temporally, and which transformations are to be applied. The structured project data object 930 therefore represents a finalized semantic edit plan prior to execution.

The rendering engine 942 operates as a deterministic execution layer. The rendering engine 942 interprets the structured project data object 930 and performs media processing operations to generate final edited media output 944. The rendering engine 942 does not reinterpret the natural language prompt 906, re-evaluate scene selection, modify timestamps, or alter semantic editing decisions. Instead, it executes the structured instructions provided in the structured project data object 930. This separation ensures that semantic reasoning is confined to upstream modules and that rendering remains predictable and reproducible.

By maintaining this architectural separation, the system improves determinism, reduces execution errors associated with model-generated code, enhances security by avoiding arbitrary code execution, simplifies debugging, and enables independent optimization of rendering infrastructure. The semantic planning logic embodied in modules 914, 924, and 928 may therefore be modified or improved without requiring changes to the rendering engine 942, and conversely, rendering infrastructure may be upgraded without altering the semantic reasoning layer. This layered design provides improved modularity, scalability, and reliability compared to systems in which semantic reasoning and rendering execution are intermingled.

### Example Embodiments and Variations

Although FIG. 9 illustrates a particular workflow arrangement, variations are contemplated. In some embodiments, the multi-modal LLM analysis module 914 and structured project generation module 928 may be implemented using a single model performing sequential reasoning steps. In certain embodiments, timestamp correction module 924 may operate before or after structured project generation. In some implementations, asset generation orchestration module 938 may operate before timeline construction, generating assets prior to insertion into timeline segments 932. In further example embodiments, the structured project data object 930 may be converted into executable code as an intermediate representation prior to rendering. In further embodiments, modules 908, 914, 924, 928, and 938 may operate in streaming or near-real-time configurations with incremental timeline updates. The system may also incorporate model optimization techniques such as quantization, speculative decoding, distributed inference, or caching of semantic embeddings to reduce latency.

In certain embodiments, the adaptive multi-modal media generation and editing system described with reference to FIGS. 7-9 employs a structured semantic planning architecture in which multi-modal analysis, timestamp reconciliation, structured project generation, and deterministic rendering are logically separated components.

Referring to FIG. 7 (700) and FIG. 9 (900), the system receives, via user input stage 702/902, one or more media files 904 and a natural language prompt 906 describing desired edits. The media files are processed by preprocessing module 704/preprocessing stage 908, which may include frame and audio extraction 910 and chunking and analysis 912. Chunking enables temporally indexed segmentation and may support distributed processing across compute resources shown in FIG. 8.

The preprocessed media representations are supplied to multi-modal LLM analysis module 706/914. The multi-modal LLM analysis module performs scene detection 916, transcription analysis 918, object tracking 920, and timecode identification 922. The module generates semantic metadata representing media content in the context of the natural language prompt.

Because model-generated timestamps may exhibit imprecision, the system further includes timestamp reconciliation module 708/924. The timestamp reconciliation module compares model-identified spoken excerpts with timecoded transcription data generated by a speech-to-text process executed in parallel within preprocessing module 704/908. Using similarity scoring techniques, including but not limited to string matching, edit distance comparison, embedding similarity, or phonetic matching, the system substitutes transcript-derived timestamps 926 for model-generated timestamps when a similarity threshold is satisfied. This process improves temporal alignment accuracy prior to structured project construction.

Following semantic analysis and optional timestamp reconciliation, structured project generation module 710/928 generates a structured project data object 930. The structured project data object conforms to a predefined schema and represents a media editing timeline. The structured project data object may include timeline segments 932, effects and transitions 934, and asset references 936. The structured representation encodes editing logic in declarative form rather than executable procedural code.

Unlike embodiments that generate executable source code, the structured project data object 930 is interpreted by rendering engine 716/942 without executing model-generated code. The rendering engine 716/942 performs deterministic media processing operations to generate final edited media output 718/944. This separation between semantic planning and deterministic execution improves system reliability, reduces runtime errors, enhances execution safety, and enables independent optimization of rendering infrastructure.

In certain embodiments, executable code generation may also be supported as an example implementation. The system may selectively generate either executable source code or structured project data objects depending on configuration parameters, model capability, or runtime conditions.

Referring to FIGS. 7 and 9, the system may further include asset planning and orchestration module 712/938. After semantic analysis, the system generates a structured list of intermediate assets required to satisfy the natural language prompt 906. The structured asset list conforms to a schema enumerating supported asset-generation tools and asset types. Each asset entry specifies an asset type and generation parameters.

Asset requests are routed to asset generation services 714/asset creation tools 940 using a predefined routing mechanism. Asset generation may include music synthesis, graphic generation, animation creation, overlay production, or other media synthesis operations. In some embodiments, a parent specification may generate multiple related assets, such as a series of lower-third overlays sharing formatting attributes but differing in content. Generated assets are incorporated into structured project data object 930 prior to rendering.

As shown in FIG. 8 (800), the system may be deployed within a networked computing environment including client devices 802, network 804, API gateway 806, application server 808, preprocessing module 812, multi-modal analysis module 814, timestamp reconciliation module 816, asset planning module 818, project generation module 822, rendering engine 826, GPU cluster 828, storage 830, and database 832. Distributed execution, message queue orchestration 824, and hardware acceleration may be employed to support scalable and near-real-time editing workflows.

Embodiments of the system, method, and computer program product may implement any combination of the features described herein. The structured project generation, asset orchestration, and timestamp reconciliation mechanisms may be implemented independently or in combination within local, distributed, cloud-based, or hybrid computing environments.

### Example User Input and Submission of Media Files and User Prompt

In an embodiment, receiving user input and submitting media files and a user prompt may include the following operations, for non-limiting examples:
a) Media File Selection: A user may select one or more media file(s) (e.g., video, audio, and/or image files) from a local storage device or a media repository (e.g., a content management system).
b) Natural Language Prompt: The user may provide a natural language description specifying desired edits (e.g., trimming, splicing, compositing, color correction, audio enhancement, subtitle addition) for the media file(s).
c) Submission: The media files and the user prompt may be submitted to a system of embodiments via an appropriate user interface, which may be a web-based interface, a command-line interface, or another suitable mechanism.

### Example Media Preprocessing and Chunking

In an embodiment, media preprocessing and chunking may include the following operations, for non-limiting examples:
a) Preprocessing: A system of embodiments may preprocess media file(s) by extracting frames (for video) and corresponding audio segments. For video files, extraction may occur at rates ranging from one frame per second to higher rates (e.g., 10-30 frames per second) depending on a desired granularity of analysis.
b) Chunking: To accommodate language model, e.g., LLM, context window limitations, large media file(s) may be divided into manageable chunks. Each chunk may be tagged with metadata (e.g., timecodes relative to the original media file) to ensure temporal continuity and contextual integrity.

### Example Multi-Modal Language Model Analysis

In an embodiment, multi-modal language model, e.g., LLM, analysis may include the following operations, for non-limiting examples:
a) Input Composition: A preprocessed media (or individual chunks) along with a natural language prompt may be provided to a multi-modal language model.
b) Generation of Intermediate Analysis: The language model may generate an intermediate analysis that includes details such as transcriptions, scene changes, object detections, timecodes, pixel coordinates, and other metadata necessary to inform an editing process. Specific details included in the intermediate analysis may be determined by the language model based on requirements of a user prompt and media content.
c) Flexible Output Format: The intermediate analysis may be generated in a standard format (e.g., JSON, XML, or delimited plain text) or a novel format, at the language model's discretion, ensuring the intermediate analysis is easily consumable by a subsequent code-generation step.

### Example Code Generation Using a Second Language Model

In an embodiment, code generation using a second language model, e.g., LLM, may include the following operations, for non-limiting examples:
a) Preparation of Detailed Prompt: An intermediate analysis, together with an original user prompt, may be supplied to a second language model configured for code generation. A detailed prompt may include:
   i. A specification of a programming language (e.g., Python, Java, C++, JavaScript).
   ii. Detailed information about a media editing library/SDK/API (e.g., ffmpeg, MoviePy, GStreamer, OpenCV®, AVFoundation, Amazon® Elemental MediaConvert™), which may include documentation and usage guidelines.
   iii. Descriptions of a target execution environment (e.g., memory, CPU, GPU constraints) to guide code optimization.
b) Dynamic Code Generation: The language model may generate executable code designed to perform desired media edits as described in a user prompt.

### Example Code Validation and Secure Execution

In an embodiment, code validation and secure execution may include the following operations, for non-limiting examples:
a) Pre-Execution Validation: Generated code may be validated using industry-standard code validation tools and static analysis techniques.
b) Error Handling: If validation or execution fails (e.g., due to compilation errors or runtime issues), error messages and logs may be captured and returned to a code-generation language model, e.g., LLM. A system of embodiments may then prompt the language model to revise the code, optionally iterating through multiple regeneration cycles.
c) Sandboxed Execution Environment: The validated code may be executed in a secure, sandboxed environment that employs, for non-limiting examples:
   i. Containerization or virtual machine isolation.
   ii. Resource constraints (e.g., CPU, memory, and execution time limits).
   iii. Strict access controls to prevent malicious activity.
d) Execution of Code: The code may operate on original media files to perform specified edits, generating time-based output media.

### Example Optional Quality Evaluation

In an embodiment, optional quality evaluation may include the following operations, for non-limiting examples:
a) Quality Assessment: Output media may optionally be provided to a multi-modal language model, e.g., LLM, along with an original user prompt to assess a degree of adherence to the prompt.
b) Evaluation Methods: An evaluation may include, for non-limiting examples:
   i. A single numeric score (e.g., on a scale from 0 to 100) with written justification.
   ii. A multidimensional assessment evaluating several aspects of prompt adherence.
c) Feedback Loop:
   i. If a quality evaluation does not meet predefined thresholds, a system of embodiments may automatically trigger a re-generation cycle, e.g., feeding the evaluation feedback back into prompt(s), or prompt a user for manual intervention.
   ii. A feedback loop may be designed to iteratively improve quality of output media.

### Example Delivery of Final Output

In an embodiment, delivery of final output may include the following operations, for non-limiting examples:
a) Notification and Access: Once the time-based output media meets the quality criteria, the system notifies the user. In web-hosted embodiments, the user may preview and/or download the final edited media file.
b) User Interface Considerations: The interface may include options for previewing the output without download, as well as mechanisms for the user to initiate re-generation if desired.

### Example Data Management and Storage

In an embodiment, data management and storage may include the following components and functionality, for non-limiting examples:
a) Local Storage: In a local implementation, media files, intermediate analyses, generated code, error logs, and/or quality evaluations may be stored on a user's device using an existing file system.
b) Cloud-Based Storage: In web-hosted embodiments, data may be stored using cloud-based storage solutions (e.g., Amazon S3®) and/or structured databases (relational or non-relational).
c) Adaptability: The system of embodiments may be designed to accommodate standard data management practices.

### Example Media Pre-processing

In an embodiment, a frame rate for video analysis may be varied, e.g., from one frame per second to 30 frames per second, for increased granularity.

According to another embodiment, large media files may be divided into chunks to fit within language model, e.g., LLM, context windows, with aggregation of analyses via concatenation (with metadata) or an additional language model, e.g., LLM.

### Example Language Model Configurations

In an embodiment, a single multi-modal language model, e.g., LLM, may be used for both media analysis and code generation in sequential steps.

According to another embodiment, separate, specialized language models, e.g., LLMs—one optimized for media analysis and another for code generation—may be employed.

In yet another embodiment, multiple language models, e.g., LLMs, may be deployed for specialized tasks (e.g., facial recognition, object detection) during a media analysis phase.

### Example Prompt Preprocessing

In an embodiment, an additional language model, e.g., LLM, may be used to preprocess and expand a user's prompt to enhance quality of subsequent outputs.

### Example Integration of Generative Models

According to an embodiment, in scenarios where new media element(s) are expected—for example, generating a graphic overlay specified in a user's prompt but not supplied by the user—a generative AI model may be invoked to create the expected asset(s).

### Example User Feedback Integration

Beyond automated quality evaluation, a system of embodiments may present evaluation results to a user and allow manual feedback to trigger re-generation cycles.

### Example Advantages

Embodiments provide an adaptive multi-modal media generation and editing system and method for automated media editing that leverages unique capabilities of multi-modal language models, e.g., LLMs. A novel two-stage process of embodiments—including detailed media analysis and dynamic code generation—combined with secure code execution and an optional feedback loop for quality evaluation, enables a flexible and powerful means of editing media based solely on a natural language description of a desired output. Embodiments can adapt to a variety of different environments and use cases.

Embodiments or aspects thereof may be implemented in the form of hardware including but not limited to hardware circuitry, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

The teachings of all patents, published applications, and references cited herein are incorporated by reference in their entirety.

Embodiments of the system, method, and computer program product may implement any combination of the features described herein. The structured project generation, asset orchestration, and timestamp reconciliation mechanisms may be implemented independently or in combination within local, distributed, cloud-based, or hybrid computing environments.

While example embodiments have been particularly shown and described, it will be understood by those skilled in the art that various changes in form and details may be made therein without departing from the scope of the embodiments encompassed by the appended claims.

1. A computational media editing system using multi-modal language models, the computational media editing system comprising:
a processor;
a non-transitory computer-readable memory;
a generative artificial intelligence multi-modal media editing module stored in memory, wherein the generative artificial intelligence multi-modal media editing module includes:
an input interface configured to receive: multimodal input data comprising (i) a selection of at least one input media object, and (ii) a first natural language edit prompt, the first natural language edit prompt including an indication of at least one modification to the at least one input media object;
a preprocessing module configured to extract temporally indexed media representations from the at least one input media object;
a multi-modal machine learning model configured to:
analyze at least a portion of the temporally indexed media representations and the first natural language edit prompt; and
generate an intermediate data comprising a machine-readable computational media editing artifact stored in memory, the intermediate data comprising a timeline representation including media segment references and edit parameters;
wherein the intermediate data comprises (i) a structured, non-executable project data object, or (ii) executable source code; and
a rendering engine configured to process the intermediate data and generate an edited media output.

2. The computational media editing system of claim 1, wherein the generative artificial intelligence multi-modal media editing module is configured to selectively generate the intermediate data as either the executable code or the structured, non-executable project data object based on at least one runtime condition.

3. The computational media editing system of claim 1, wherein the intermediate data is configured by the generative artificial intelligence multi-modal media editing module as the structured, non-executable project data object conforming to a predefined schema, the project data object comprising the timeline representation being configured with the media segment references and the edit parameters.

4. The computational media editing system of claim 3, wherein the intermediate data is configured as the structured, non-executable project data object constrained using grammar-constrained decoding or schema validation.

5. The computational media editing system of claim 3, wherein the rendering engine includes an interpreter configured to interpret the structured, non-executable project data object and generate the edited media output without executing model-generated source code.

6. The computational media editing system of claim 3, wherein the structured, non-executable project data object is validated against the predefined schema prior to rendering.

7. The computational media editing system of claim 3, wherein the structured, non-executable project data object is convertible into a standardized non-linear editing interchange format.

8. The computational media editing system of claim 3, wherein the rendering engine configured with an interpreter to interpret the intermediate data and generate an edited media output.

9. The computational media editing system of claim 1, wherein the intermediate data is configured by the generative artificial intelligence multi-modal media editing module with a code-generation model configured to generate the executable source code, the generated executable source code comprising the timeline representation being configured with the media segment references and the edit parameters.

10. The computational media editing system of claim 1, wherein a media object of the at least one input media object is a video object, and wherein the generative artificial intelligence multi-modal media editing module is further configured to:
pre-process the video object by performing frame extraction to generate a plurality of video frames.

11. The computational media editing system of claim 1, wherein a media object of the at least one input media object includes an audio object, and wherein the generative artificial intelligence multi-modal media editing module is further configured to:
pre-process the audio object by performing segmentation to generate a plurality of audio segments.

12. The computational media editing system of claim 1, wherein the generative artificial intelligence multi-modal media editing module is further configured to:
pre-process a media object of the at least one input media object by transforming the media object into a plurality of segments.

13. The computational media editing system of claim 12, wherein a given segment of the plurality of segments is paired with a corresponding metadata object, the metadata object including a timecode of the segment in the media object.

14. The computational media editing system of claim 12, wherein the plurality of segments corresponds to a respective plurality of context windows of the first language model.

15. The computational media editing system of claim 14, wherein the generative artificial intelligence multi-modal media editing module is configured to process the at least one input media object using the first language model by:
generating a plurality of intermediate outputs corresponding to the plurality of segments; and
aggregating the plurality of intermediate outputs to produce the intermediate data.

16. The computational media editing system of claim 1, wherein the generative artificial intelligence multi-modal media editing module further includes a timestamp reconciliation module executed by the processor and configured to improve temporal alignment precision of the timeline representation by:
generating timecoded transcription data via a speech-to-text process executed in parallel within the preprocessing module;
aligning model-identified spoken excerpts to transcription segments using similarity scoring;
selecting transcript-derived timestamps when a computed similarity metric satisfies a threshold condition; and
generating the intermediate data using the selected timestamps.

17. The computational media editing system of claim 1, wherein the selected timestamps provide control anchors that convert natural language intent into temporally bounded edit operations in the intermediate data.

18. The computational media editing system of claim 1, wherein the at least one parameter includes at least one of: a transcription, a scene change, object detection, a timecode, and a pixel coordinate.

19. The computational media editing system of claim 1, wherein the intermediate data is in: JavaScript Object Notation (JSON) format, Extensible Markup Language (XML) format, plain text format, or a dynamic format determined by the first language model.

20. The computational media editing system of claim 1, wherein the generative artificial intelligence multi-modal media editing module is further configured to, based on the first natural language edit prompt, construct a first instruction prompt, the first instruction prompt including at least one definition of the intermediate data, and wherein the generative artificial intelligence multi-modal media editing module is configured to process the at least one input media object using the first language model based on the first instruction prompt.

21. The computational media editing system of claim 1, wherein the generative artificial intelligence multi-modal media editing module is further configured to, based on (i) the first natural language edit prompt and (ii) the intermediate data, construct a second instruction prompt, the second instruction prompt including at least one of: (i) an indication of a programming language, (ii) an indication of at least one media editing component, and (iii) at least one property of a target execution environment, and wherein the generative artificial intelligence multi-modal media editing module is configured to process the intermediate data using the second language model based on the second instruction prompt.

22. The computational media editing system of claim 21, wherein the second instruction prompt is an encapsulated internal prompt not externally exposed to a user.

23. The computational media editing system of claim 1, wherein the generative artificial intelligence multi-modal media editing module is further configured to:
perform validation of the media editing code; and
responsive to a result of the validation indicating that the media editing code is not validated:
process the intermediate data using the second language model to generate the media editing code, further based on the result of the validation.

24. (canceled)

25. The computational media editing system of claim 1, wherein the media editing code is executed in a secure environment,
wherein the secure environment is configured with at least one of: (i) containerization, (ii) virtual machine isolation, (iii) one or more resource constraints, and (iv) one or more access control mechanisms.

26. The computational media editing system of claim 1, wherein the generative artificial intelligence multi-modal media editing module is further configured to:
based on the first natural language edit prompt, process the at least one time-based output media object using a third language model to generate an output quality evaluation, the output quality evaluation representing a degree of accuracy in performing the at least one modification, the third language model being a multi-modal language model; and
responsive to the degree of accuracy being below a threshold value, (i) generate the intermediate data, (ii) generate the media editing code, and (iii) transform the at least one input media object, wherein at least one of (i), (ii), and (iii) is further based on the output quality evaluation.

27. The computational media editing system of claim 26, wherein the output quality evaluation includes at least one of: (i) a numeric score, (ii) a natural language assessment, and (iii) a multidimensional assessment.

28. The computational media editing system of claim 1, wherein first language model includes multiple language models, and wherein a given language model of the multiple language models is configured to perform facial recognition or object detection.

29. The computational media editing system of claim 1, wherein the at least one modification includes at least one feature of a timeline-based editing system: trimming, splicing, compositing, color correction, audio enhancement, subtitle addition.

30. The computational media editing system of claim 1, wherein the at least one modification includes creation of a new media element, and wherein the media editing code is further configured to create the new media element using a generative model.

31. A computer-implemented method for automated media editing using multi-modal language models, the method comprising:
configuring a generative artificial intelligence multi-modal media editing module stored in memory including:
configuring an input interface to receive: multimodal input data comprising (i) a selection of at least one input media object, and (ii) a first natural language edit prompt, the first natural language edit prompt including an indication of at least one modification to the at least one input media object;
configuring a preprocessing module to extract temporally indexed media representations from the at least one input media object;
configuring a multi-modal machine learning model to:
analyze at least a portion of the temporally indexed media representations and the first natural language edit prompt; and
generate intermediate data comprising a machine-readable computational media editing artifact stored in memory, the intermediate data comprising a timeline representation including media segment references and edit parameters; and
configuring a rendering engine to process the intermediate data and generate an edited media output;
wherein the intermediate data comprises (i) a structured, non-executable project data object, or (ii) executable source code.
